(19) United States
(12) Patent Application Publication
(10) Pub. No.: US 2006/0247039 A1
(43) Pub. Date: Nov. 2, 2006

(54) Systems and methods for providing targeted information in the context of electronic gaming

(76) Inventors: Byron Lerner, Roslyn, NY (US); Clifford Lerner, New York, NY (US)

Correspondence Address: FITZPATRICK CELLA HARPER & SCINTO, 30 ROCKEFELLER PLAZA, NEW YORK, NY, 10112, US

(21) Appl. No.: 11/120,438

(22) Filed: May 2, 2005

(51) Int. Cl. A63F 13/00

(52) U.S. Cl. 463/29; 463/42

(57) ABSTRACT

A system and method for providing information to a user in the context of an online game, in which game units are allocated to the user. The system and method include acquiring user profile data relating to at least one of personal characteristic of the user, retrieving information items from a database based on the user profile data, associating the information items with the game units allocated to the user, and presenting the game units to the user with the information items displayed on the game units.

### BACKGROUND OF THE INVENTION

1. Field of the Invention

The present invention relates to systems and methods for integrally providing information in the context of electronic gaming, targeted specifically to a user based upon acquired profile data. In a particular embodiment, the present invention relates to online gaming in which a player is provided with targeted advertising or information relating to potential matches in an online dating service, in a manner integral to the online game.

2. Description of Related Art

Conventional online gaming systems may provide advertising during the playing of a game over the Internet. For example, U.S. Pat. No. 6,625,578 to Spaur discusses online game playing combined with advertising. A number of client machines are connected to game servers, which in turn may be connected to advertising servers. An advertisement may be displayed on the client machine following the completion of a game for a predetermined period of time. In addition, advertisements may be displayed continuously during a game using game elements, such as card backs and banners. A database is used to store information relating to each advertisement, including when the advertisement was displayed and the reaction to the advertisement by each player on each client machine.

In Spaur, the advertisements presented to the user are taken from an advertising database according to a predetermined sequence, and the same generic advertisements are displayed to all of the players of the online game. The system, as noted above, keeps track of whether each player has shown interest in a particular advertisement and provides further information on products in which the user expresses interest. However, the system does not select the advertisements in the first instance based on characteristics or preferences of the user. Consequently, the displayed advertisements bear no specific relation to the user and may be utterly irrelevant and inapt. Thus, a shortcoming of this approach is that it does not provide advertising or other information in a targeted manner, based on acquired user profile data.

Conventional online data services merely present dating information in the context of an online discussion, i.e., “chat room,” such as in U.S. Patent Application Publication No. 2002/0116458 A1, or a searchable database of user profiles. Such systems do not present information to the user in the context of an online game. Moreover, such systems often require mundane keyword and menu-based searches and tedious browsing of search results and thus do not provide an engaging method of performing searches and analyzing results.

Conventional online gaming systems may also provide information relating to dating. For example, the online data service “DateLife” provides information on potential dating matches during a poker game. “Dating Poker at DateLife.com,” website [online], retrieved on Nov. 16, 2004 from the Internet: <URL: www.datelife.com/games/datingpoker.html>. The information is provided in a window on the same screen on which a poker game is played. However, the information is not presented in a manner that is integral to the online game.

There is a need, therefore, for systems and methods that integrally provide targeted information in the context of electronic gaming, based on the user's personal characteristics and dating partner criteria. There is also a need for systems and methods that rise above the banality of conventional online dating services to provide an engaging method of searching for potential dating partners. Furthermore, there is a need for electronic gaming in which a player is provided with targeted advertising or information relating to potential dating matches in a manner integral to the electronic game.

### SUMMARY OF THE INVENTION

In one aspect, the present invention provides a system, method, and computer code for providing information to a user in the context of an online game in which game units are allocated to the user. The present invention includes acquiring user profile data relating to at least one of personal characteristic of the user, retrieving information items from a database on the basis of the acquired user profile data, and associating the information items with the game units allocated to the user. The game units are presented to the user with the information items displayed on the game units in a manner that is integral to the game.

Embodiments of the present invention may include one or more of the following features. The information items may be targeted advertisements based on the acquired user profile data and may function as links to access information relating to the advertisement. The game units may function as links to allow purchase of an item in the advertisement and may allow purchase of the item using the user's accumulated winnings from the online game.

The user profile data may include criteria relating to characteristics of potential dating partners desired by the user, and the information items correspond to potential dating partners based on the user profile data. The game units may function as links to access information on the potential dating partners.

The game units may be playing cards and the associated information item for each playing card may be displayed on the back of the playing card. The playing cards may be turned over to the front to display the rank and suit so that the associated information item is still visible. Alternatively, the associated information item for each playing card may be displayed on the front of the playing card so as to leave visible card rank and suit.

The associating of the information items with the game units may include selecting retrieved information items so as to correspond to the game units on a one-to-one basis, based at least in part on a score for each of the retrieved information items determined based on the user profile data. The retrieved information items may be selected based at least in part on which of the information items correspond to other users who are currently playing the online game.

### BRIEF DESCRIPTION OF THE DRAWINGS

FIG. 1 shows a webpage that presents information on potential dating partners to the user in the context of an online poker game.

FIG. 2 shows a webpage that presents information relating to potential dating partners to the user in the context of an online poker game, in which the information is displayed on the backs of the playing cards.

FIG. 3 is a block diagram showing a system for providing information to a user in the context of an online game.

FIG. 4 is a block diagram showing a system for providing information to a user in the context of an online game, in which information is retrieved from a dating website.

FIG. 5 shows a webpage that presents targeted advertisements to the user based on user profile data.

### DETAILED DESCRIPTION OF THE PREFERRED EMBODIMENTS

In general, the present invention involves a method of providing information to a user in the context of an electronic game, e.g., an electronic game that is played “online” over a network, such as the Internet. The online game may be presented to the user as a webpage of an Internet website via the user's web browser. Almost any card, board, video, slot machine, or table game may be adapted for play online. Gambling-related games, e.g., poker, keno, bingo, blackjack, roulette, and slots, are particularly suitable, as they potentially allow for an online game provider to generate revenue. As further discussed below, the present invention retrieves information from a database based on user profile data, which includes the user's personal characteristics and dating partner criteria, and presents the information to the user using components of the online game. Of course, the electronic game and information database may also be provided “offline,” i.e., provided on an electronic storage medium, such as the hard disk of the user's computer, so that the user need not be connected to a network.

As used herein, the term “computer” may refer to a single computer or to a system of interacting computers. Generally speaking, a computer is a combination of a hardware system, a software operating system and perhaps one or more software application programs. Examples of computers include, without limitation, IBM-type personal computers (PCs) having an operating system such as DOS, Windows, OS/2 or Linux; Macintosh computers; graphical work stations, such as Sun Microsystems and Silicon Graphics Workstations having a UNIX operating system; PalmPilots; and Pocket PCs.

“Network” means a connection between any two or more computers, which permits the transmission of data. An example of a network, although it is by no means the only example, is the Internet.

“Web page” means any document written in mark-up language, including, but not limited to, HTML (hypertext mark-up language) or VRML (virtual reality modeling language), dynamic HTML, XML (extended mark-up language) or related computer languages thereof, reachable through one particular URL (Uniform Resource Locator).

“Web site” means at least one Web page, and more commonly a plurality of Web pages, virtually connected to form a coherent group.

“Web browser” means any software program that can display text, graphics, or both, from Web pages on Web sites. Examples of Web browsers include, without limitation, Netscape Navigator and Microsoft Internet Explorer.

“Web server” refers to a computer or other electronic device that is capable of serving at least one Web page to a Web browser.

The phrase “display a Web page” or “access a Web page” includes all actions necessary to render at least a portion of the information on the Web page available to the computer user. As such, the phrase includes, but is not limited to, the static visual display of static graphical information, the audible production of audio information, the animated visual display of animation and the visual display of video stream data.

For the present invention, a software application could be written in substantially any suitable programming language, which could easily be selected by one of ordinary skill in the art. The programming language chosen should be compatible with the computer by which the software application is executed, and in particular with the operating system of that computer. Examples of suitable programming languages include, but are not limited to, C, C++, CGI, Java, and Visual Basic. Furthermore, the functions of the present invention, when described as a series of steps for a method, could be implemented as a series of software instructions for being operated by a data processor, such that the present invention could be implemented as software, firmware or hardware, or a combination thereof.

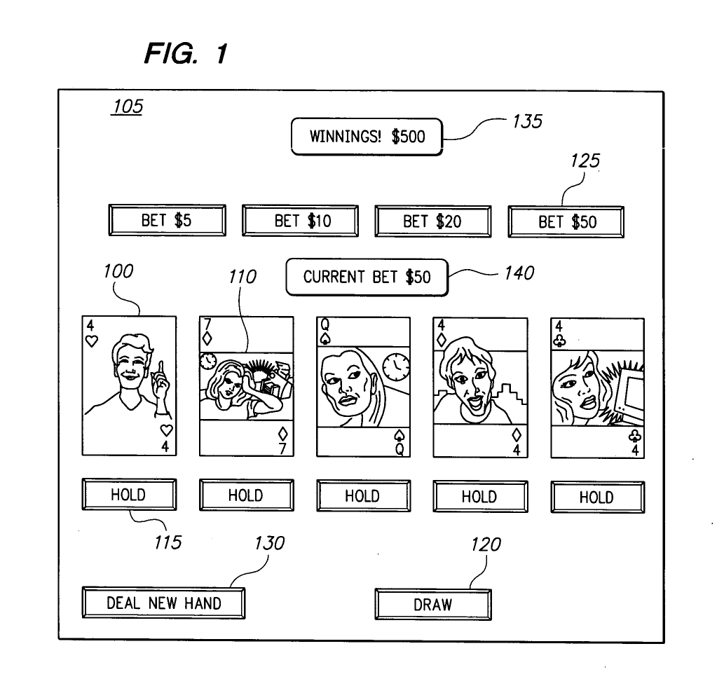

As shown in FIG. 1, during play of the electronic game, game units, such as playing cards 100, poker chips, dice, slot machine reel positions, are allocated and displayed to the user as a webpage. For example, in an electronic poker game, such as five-card stud, five playing cards may be dealt to the user and displayed on the user's computer screen 105 by the user's web browser. Each of the cards has a rank and suit, as in a traditional deck of cards, and constitutes an individual game unit. Information retrieved from a database is associated with the game units and displayed overlaid on the game unit, e.g., in a central portion of the face of the card 100. Of course, any element or component of a game may be utilized as a game unit for the display of information, including any portions of a game board or any type of game piece.

For example, the system may retrieve information relating to potential dating partners, such as a photograph 110, based on user profile data. As discussed in further detail below, the user profile data may include personal characteristics of the user that are used to determine a compatible match in a dating partner, such as age, weight, height, hair color, eye color, likes and dislikes, religion, hobbies, personality type, political affiliation, etc. In addition, the profile data may include criteria relating to the user's predilections with respect to potential dating partners. These criteria may include categories that are similar in nature to the personal characteristics of the user, but that relate to the potential dating partner, e.g., desired age, desired hair color, desired eye color, etc. The resulting information items retrieved from the database are then associated with the game units, e.g., the playing cards 100, and presented to the user in a manner integral to the game.

In the embodiment shown in FIG. 1, a number of potential dating partners are selected from among those retrieved from the database, and a photograph 110 of one of the selected potential dating partners is displayed on the face of each of the playing cards 100 dealt to the user. The photograph 110 is displayed in a manner that does not obscure the rank and suit of the card 100 and therefore does not interfere with the functionality of the game units as part of the electronic game. The selected potential dating partners may be limited to those who are currently playing the electronic game online.

In this manner, the information to be imparted to the user, e.g., a photograph 110, is displayed in a manner integral to the electronic game, in the sense that the information is displayed on a portion of the screen directly involved in game play, e.g., on the face of the playing cards 100, rather than merely being displayed on an otherwise unused portion of the screen. Thus, the photograph 110, or other information, is not easily ignored or overlooked by the user. Moreover, the user is able to view the information without being unduly distracted from the electronic game.

Thus, in this embodiment, information items are associated with the game units on a one-to-one basis. The information items to be displayed on the game units may be selected from the retrieved information items through various means, including random selection or an algorithm. For example, the items may be selected based on a calculated score representative of how closely the characteristics of the potential dating partner match the user profile data.

The game units may serve as links to allow the user to access information on the potential dating partners, so that the user can click on the corresponding photograph 110 or a button (not shown) to retrieve additional information or take a related action. For example, the link may lead to a profile screen providing personal characteristics for the potential dating partner. In addition, the link may lead to a facility for chat or email communication with the potential dating partner.

The user manipulates the game units in accordance with the rules of the game being played. For example, in the poker game depicted in FIG. 1, the user may select a certain number of the cards 100 to be held using “Hold” buttons 115 at the bottom of each card 100, and the remaining cards are discarded and replaced with newly dealt cards when the user clicks on the “Draw” button 120. Other buttons on the display allow the user to select an amount to bet 125 and to deal a new hand 130. The screen 105 also displays the user's winnings 135 and amount currently bet 140.

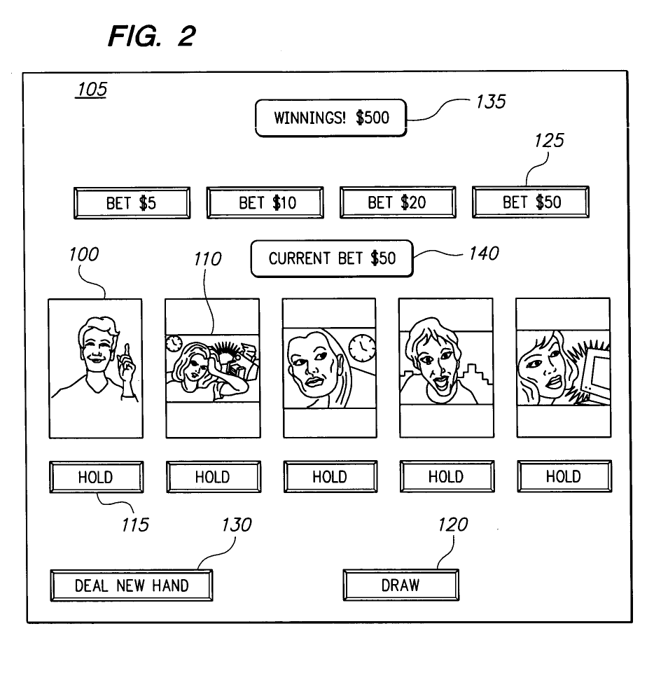

FIG. 2 shows an alternative embodiment in which the information items, e.g., the potential dating partner photographs 110, are displayed on the back of the game units, e.g., the cards 100 dealt to the user. The cards 100 may be displayed face down until the user has finished examining the information items, at which point the user may click on the card 100, or a button (not shown), to turn the card 100 over to display the rank and suit.

This embodiment may allow the user to select certain game units and to redraw the remaining units before the cards are turned over to the front, e.g., using the “Hold” 115 and “Draw” 120 buttons. In this manner, the user can discard undesirable potential dating partners and obtain fresh choices before actually seeing the face of the cards. The system may or may not actually change the rank and suit of the cards that have been redrawn, depending upon the particular schema for game play developed by the electronic game provider. When the cards 100 are turned over to the front to display the rank and suit, it may be done so that the associated information item is still visible, i.e., the photographs 110 of the potential dating partners may be shown in the center of the front face of the playing cards 100, as shown in FIG. 1.

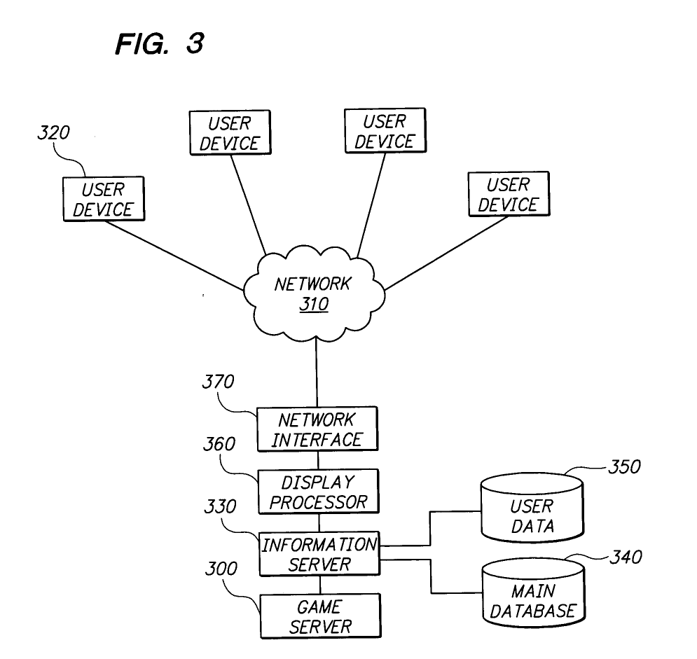

FIG. 3 shows an embodiment of the system for playing the electronic game online, which includes a game server 300, i.e., a computer that stores and executes the online game software. The game software is designed to operate over a network 310, such as the Internet, to provide the functionality of the game to a number of users on their respective user device 320, which may be, for example, a personal computer. The game server 300 is connected to an information server 330, which is adapted to associate information items with the game units based on the user profile data. Specifically, when the game server allocates game units to the user, e.g., deals playing cards to the user in a poker game, the information server 330 provides an information item to be displayed on each game unit, e.g., a photograph 110 of a potential dating partner.

The information server 330 retrieves the information items from a main database 340 based on the user profile data, which may be stored in a separate user database 350. For example, the user profile data may include a set of desired criteria for potential dating partners, such as age, weight, height, hair color, eye color, likes and dislikes, religion, hobbies, personality type, political affiliation, etc., and the information server 330 may perform a search of stored dating partner information in the main database 340 to retrieve entries that meet these criteria. Alternatively, or in addition to specifying dating partner criteria, the user profile data may include personal characteristics of the user, which are used to find appropriate matches in the main database 340 based on predicted compatibility or other bases, such as characteristics sought by the potential dating partners whose information is stored in the main database 340.

Generally speaking, the information retrieved by the information server 330 from the main database 340 includes information relating to potential dating partners, such as photographs and personal data. The information is provided by those wishing to be subjected to the date screening process and possibly selected to be asked on a date. Of course, a user may choose to make themselves available as a potential dating partner, to seek a potential dating partner, or both.

A particular number of the retrieved entries are selected to be displayed on the game units, e.g., one for each game unit. As noted above, the information items to be displayed on the game units may be selected from the retrieved information items through various means, including random selection or an algorithm. A display processor 360 prepares the game units for presentation to the users with the information items displayed on the game units, as discussed above. For example, the display processor 360 overlays photographs 110 of potential dating partners onto the front or back face of playing cards 100 to be dealt to the user. The display processor 360 transmits the game units to the users via a network interface 370 that is connected to the network 310, e.g., the Internet.

The user profile database 350 and main database 340 may be implemented as separate databases, as a single database, or as a single database that is logically divided into two sub-databases. Moreover, these databases are not necessarily stored on a separate physical storage device or devices. Rather, the data contained therein may be stored by any appropriate means, including on the storage device of the information server 330. Likewise, although the game server 300, information server 330, display processor 360, and network interface 370 are depicted separately in FIG. 3, the functions thereof may be integrated on a single server or any number of separate computers.

The information in the user profile database 350 and the main database 340 may be obtained and stored before the user accesses the online game website. There are a number of ways in which this may be done. For example, the information server 330, in conjunction with the display processor 360 and network interface 370, may present a website that allows users to enter user profile data, e.g., personal characteristics of the user and desired dating partner criteria, to allow the user to find a potential dating partner as described above. The user may also enter personal data, including a photograph, to make themselves available as a potential dating partner.

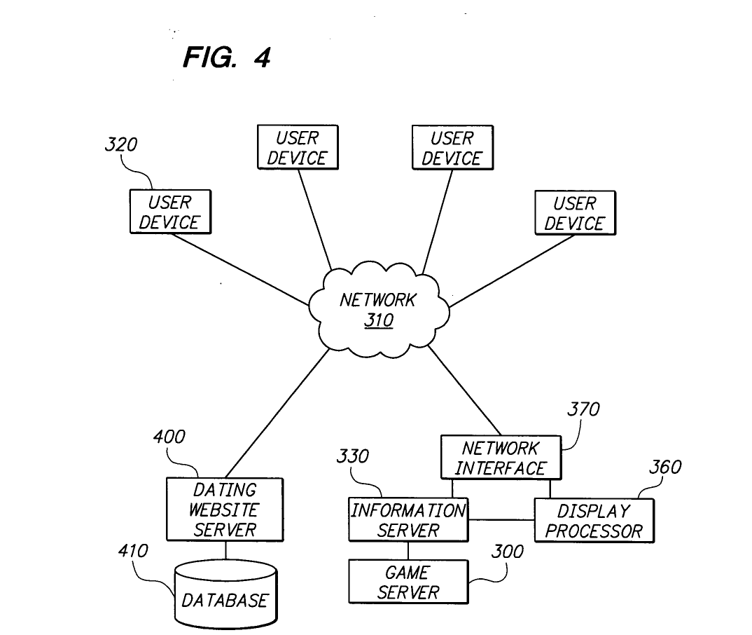

As a further example, as shown in FIG. 4, the information stored in the user profile database 350 and the main database 340 may come from a separate dating website. In this configuration, the information server 330 accesses the dating website server 400 and its associated database 410 via a network 310, in which case the information server 330 is direction connected to the network interface 370. The information server 330 also is connected to the game server 300 and the display processor 360, as in the previous embodiments. The information may be retrieved from the dating website server 400 while the online game is in progress. Alternatively, the information may be retrieved ahead of time and stored by the information server 330 for use during the online game. The information server 330 may periodically update the stored information by accessing the dating website server 400.

In addition, as discussed above, the electronic game and information database may also be provided “offline,” i.e., provided on an electronic storage medium, such as the hard disk of the user's computer, so that the user need not be connected to a network. Such offline configurations may include, for example, electronic casino gambling machines, such as slot machines and electronic poker machines.

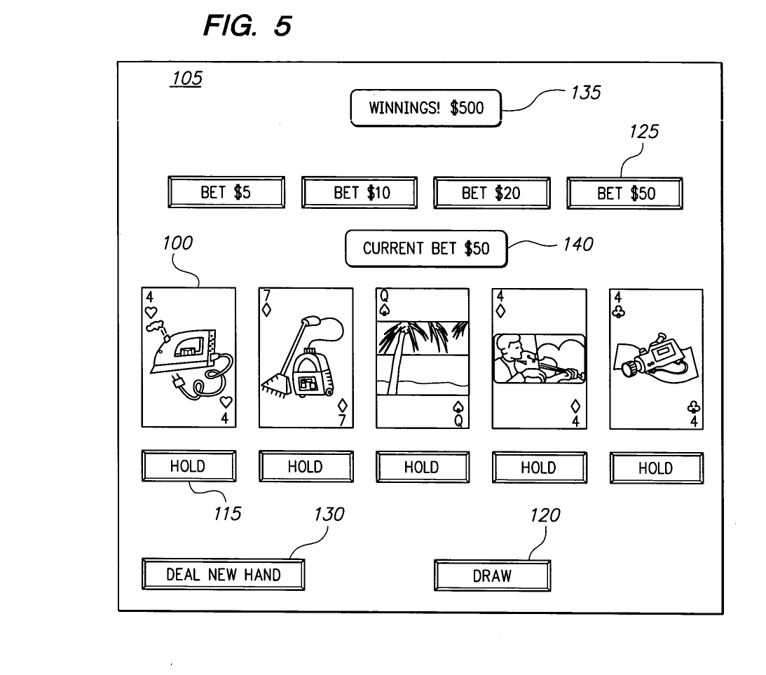

In another embodiment, as shown in FIG. 5, the information items displayed on the game units may be targeted advertisements based on the user profile data. For example, the game units, e.g., playing cards, may display advertisements that have been specifically selected for the user based on the user's personal characteristics in the user database. More specifically, the playing cards in this example contain advertisements for products and services, e.g., appliances, travel services, music, and electronic equipment, that have been selected based on the user's hobbies and interests.

The advertising information may be stored and accessed in a manner similar to the dating information discussed above with respect to FIGS. 3 and 4. Of course, it is possible for a system to present both dating information and advertising information to the user. For example, the advertising information initially may be presented on the back of the playing cards, as shown in FIG. 2, followed by dating information when the cards are flipped over, as shown in FIG. 1.

In a manner similar to the embodiments discussed above, the game units may function as links to access information relating to the advertisement. In other words, the user may click on an advertisement that is found to be appealing to access further information regarding the associated product or service. The game units may also function as links to allow the user to purchase the item or service shown in the advertisement. One convenient way in which this may be done is to allow the user to purchase an item or service in an advertisement with the user's accumulated winnings from the online game. In contrast to a purchase made with a credit card, this arrangement encourages user purchases, as it may subjectively be viewed by the user as being made without spending “real money.”

The foregoing detailed description is intended to be illustrative and not limiting of the present invention, which is defined by the claims set forth below.

What is claimed is:

1. A method of providing information to a user in the context of an online game in which game units are allocated to the user, the method comprising:
acquiring user profile data relating to at least one of personal characteristic of the user;
retrieving information items from a database on the basis of the acquired user profile data;
associating the information items with the game units allocated to the user; and
presenting the game units to the user with the information items displayed on the game units in a manner that is integral to the game.

2. The method of claim 1, wherein the information items are targeted advertisements based on the acquired user profile data.

3. The method of claim 2, wherein the game units function as links to access information relating to the advertisement.

4. The method of claim 2, wherein the game units function as links to allow purchase of an item in the advertisement.

5. The method of claim 2, wherein the game units function as links to allow purchase of an item in the advertisement using the user's accumulated winnings from the online game.

6. The method of claim 1, wherein the user profile data comprises criteria relating to characteristics of potential dating partners desired by the user, and the information items correspond to potential dating partners based on the user profile data.

7. The method of claim 6, wherein the game units function as links to access information on the potential dating partners.

8. The method of claim 1, wherein the game units are playing cards and the associated information item for each playing card is displayed on a back of the playing card.

9. The method of claim 8, further comprising turning at least one of the playing cards over to the front to display the rank and suit, wherein the associated information item is still visible.

10. The method of claim 1, wherein the game units are playing cards and the associated information item for each playing card is displayed on a front of the playing card so as to leave visible card rank and suit.

11. The method of claim 1, wherein the associating of the information items with the game units comprises selecting a plurality of the retrieved information items so as to correspond to a plurality of game units on a one-to-one basis, based at least in part on a score for each of the retrieved information items determined based on the user profile data.

12. The method of claim 1, wherein the associating of the information items with the game units comprises selecting a plurality of the retrieved information items based at least in part on which of the information items correspond to other users who are currently playing the online game.

13. A method of providing dating information, the method comprising:
allocating game units to a user as part of a game played over a network;
retrieving potential dates from a database based on stored user characteristics and desired date criteria;
selecting at least a portion of the potential dates and associating the selected potential dates with the game units allocated to the user; and
displaying the game units on a user device with the potential dates displayed on the game units.

14. The method of claim 13, further comprising providing a link on at least one of the game units to connect the user to at least one of chat communication with the associated potential date, e-mail communication with the associated potential date, and a dating profile of the associated potential date.

15. The method of claim 13, wherein the game units are playing cards and photographs of the potential dates are displayed on backs of the playing cards.

16. The method of claim 15, further comprising turning at least one of the playing cards over to the front to display the rank and suit, wherein the associated information item is still visible.

17. The method of claim 13, wherein the game units are playing cards and photographs of the potential dates are displayed on fronts of the playing cards so as to leave visible card rank and suit.

18. A system for providing information to a user in the context of an online game in which game units are allocated to the user, the system comprising:
a game server adapted to execute software over a network to provide the functionality of the online game to the user;
a database for storing user profile data relating to at least one of personal characteristic of the user;
a database from which information items are retrievable based on the user profile data;
an information server adapted to associate the information items with the game units based on the user profile data; and
a display processor that presents the game units to the user with the information items displayed on the game units.

19. The system of claim 18, wherein the information items are targeted advertisements based on the user profile data.

20. The system of claim 19, wherein the game units function as links to access information relating to the advertisement.

21. The system of claim 19, wherein the game units function as links to allow purchase of an item in the advertisement.

22. The system of claim 19, wherein the game units function as links to allow purchase of an item in the advertisement using the user's accumulated winnings from the online game.

23. The system of claim 18, wherein the user profile data comprises criteria relating to characteristics of potential dating partners desired by the user, and the game units correspond to potential dating partners based on the user profile data.

24. The system of claim 23, wherein the game units function as links to access information on the potential dating partners.

25. The system of claim 18, wherein the game units are playing cards and the associated information item for each playing card is displayed on a back of the playing card.

26. The system of claim 25, wherein at least one of the playing cards is turned over to the front to display the rank and suit so that the associated information item is still visible.

27. The system of claim 18, wherein the game units are playing cards and the associated information item for each playing card is displayed on a front of the playing card so as to leave visible card rank and suit.

28. The system of claim 18, wherein the information processor is adapted to associate the information items with the game units by selecting a plurality of the retrieved information items so as to correspond to a plurality of game units on a one-to-one basis, based at least in part on a score for each of the retrieved information items determined based on the user profile data.

29. The system of claim 18, wherein the associating of the information items with the game units comprises selecting a plurality of the retrieved information items based on which of the information items correspond to other users who are currently playing the online game.

30. A server for providing information to a user in the context of an online game in which game units are allocated to the user, the system comprising:
a game processor adapted to execute software over a network to provide the functionality of the online game to the user;
a database for storing user profile data relating to at least one of personal characteristic of the user;
a database from which information items are retrievable based on the user profile data;
an information processor adapted to associate the information items with the game units based on the user profile data; and
a display processor that presents the game units to the user with the information items displayed on the game units.

31. The server of claim 30, wherein the information items are targeted advertisements based on the user profile data.

32. The server of claim 30, wherein the user profile data comprises criteria relating to characteristics of potential dating partners desired by the user, and the game units correspond to potential dating partners based on the user profile data.

33. A system for providing information to a user in the context of an online game in which game units are allocated to the user, the system comprising:
means for acquiring user profile data relating to at least one of personal characteristic of the user;
means for retrieving information items from a database on the basis of the acquired user profile data;
means for associating the information items with the game units allocated to the user; and
means for presenting the game units to the user with the information items displayed on the game units in a manner that is integral to the game.

34. The system of claim 33, wherein the information items are targeted advertisements based on the acquired user profile data.

35. The system of claim 33, wherein the user profile data comprises criteria relating to characteristics of potential dating partners desired by the user, and the information items correspond to potential dating partners based on the user profile data.

36. A computer program product, including instructions in computer-readable form, for providing information to a user in the context of an online game in which game units are allocated to the user, the instructions comprising code for:
acquiring user profile data relating to at least one of personal characteristic of the user;
retrieving information items from a database on the basis of the acquired user profile data;
associating the information items with the game units allocated to the user; and
presenting the game units to the user with the information items displayed on the game units in a manner that is integral to the game.

37. The computer program product of claim 36, wherein the information items are targeted advertisements based on the acquired user profile data.

38. The computer program product of claim 36, wherein the user profile data comprises criteria relating to characteristics of potential dating partners desired by the user, and the information items correspond to potential dating partners based on the user profile data.
